(19) United States
(12) Patent Application Publication
(10) Pub. No.: US 2004/0249661 A1
(43) Pub. Date: Dec. 9, 2004

(54) System and method for shipment control

(76) Inventor: Po-Hsuan Wu, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/831,674

(22) Filed: Apr. 23, 2004

(30) Foreign Application Priority Data
Apr. 23, 2003 (TW) 92109513

(51) Int. Cl. G06F 17/60

(52) U.S. Cl. 705/1

(57) ABSTRACT

A system for shipment control includes a shop floor control database (2), a logistics database (3), a scanner (5), a client computer (6), a server (1), and a network (7) interconnecting the above devices. The shop floor control database stores data on vehicles, IDs of detailed records on shipment, and IDs of shipper instructions. The logistics database stores inventory data. The server further includes a data maintaining module (20) for adding, modifying, querying, and deleting the data on the vehicles and data on cargoes; a checking module (30) for checking whether vehicles are loaded with correct cargoes; and a cargo amount updating module (40) for updating inventory data stored in the logistics database in accordance with data on loaded cargoes and the detailed records on shipment. A related method for shipment control is also disclosed.

### BACKGROUND OF THE INVENTION

1. Field of the Invention

The present invention relates to a computer data processing system in a management information system, and especially to a system and method for shipment control via distributed computers.

2. Background of the Invention

Cargo checking is an important step during shipment. The procedure of cargo checking generally comprises the steps of: checking IDs and amounts of cargo in accordance with client information and vehicle information; and checking the quality of the cargo. Conventionally, cargo checking relies mostly on manual work. That is, operators check items of cargo one by one in accordance with a shipment form, and checking the quality of the cargo by way of random spot checking. Even though it is necessary for the operators to spot check manually, it is inefficient for them to also tally up the cargo manually.

It is usually more efficient for cargo checking to utilize modern information devices rather than manual labor. For example, Taiwan Patent Issue No. 515966 entitled “System and Method For Cargo Checking” discloses a system for cargo checking during stocking and shipment. In this system, detailed records on shipment from an external information system are stored in a database via a network. Operators obtain corresponding detailed records on shipment in accordance with IDs of detailed records on shipment, read data stored in the detailed records on shipment, and check cargo in accordance with the data.

However, the above-described system cannot efficiently control the procedure of cargo checking, and cannot trace vehicles for shipment. Further, the system cannot update inventory data in real time.

### SUMMARY OF THE INVENTION

Accordingly, a first objective of the present invention is to provide a system for shipment control which can efficiently control the procedure of shipment, and trace vehicles for shipment.

A second objective of the present invention is to provide a method for shipment control which can efficiently control the procedure of shipment, and trace vehicles for shipment.

In order to achieve the first above-mentioned objective, a system for shipment control in accordance with the present invention comprises a shop floor control database, a logistics database, a scanner, a client computer and a server. The shop floor control database stores data on vehicles, IDs of detailed records on shipment, and IDs of shipper instruction. The logistics database stores inventory data. The scanner scans bar codes of the vehicles and cargoes. The client computer is used to input and query detailed records on shipment, shipper instructions, and basic data on the vehicles. The server comprises: a data maintaining module for adding, modifying, querying, and deleting data on the vehicles and cargoes; a checking module for checking whether vehicles are loaded with correct cargoes; and a cargo amount updating module for updating inventory data stored in the logistics database in accordance with data on loaded cargoes and the detailed records on shipment.

In order to achieve the second above-mentioned objective, a method for shipment control in accordance with the present invention comprises the steps of: (a) inputting basic data on vehicles to a shop floor control database; (b) inputting an ID of a vehicle to check the vehicle in accordance with the basic data on the vehicles stored in the shop floor control database; (c) inputting an ID of a detailed record on shipment and storing the ID in the shop floor control database; (d) inputting an ID of a shipper instruction and storing the ID in the shop floor control database; (e) checking data stored in the detailed records on shipment in accordance with the ID of the detailed record on shipment; (f) checking the shipper instruction in accordance with the ID thereof; (g) inputting bar codes of a cargo and checking data stored in the detailed record on shipment; and (h) updating inventory data stored in a logistics database.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware configuration of a system for shipment control in accordance with a preferred embodiment of the present invention, together with an information system;

FIG. 2 is a schematic diagram of function modules of the server of the system of FIG. 1;

FIG. 3 is a data flow chart of the system of FIG. 1; and

FIG. 4 is a flow chart of preferred operation of the system of FIG. 1.

### DETAILED DESCRIPTION OF PREFERRED EMBODIMENTS OF THE INVENTION

Reference will now be made to the drawings to describe the present invention in detail.

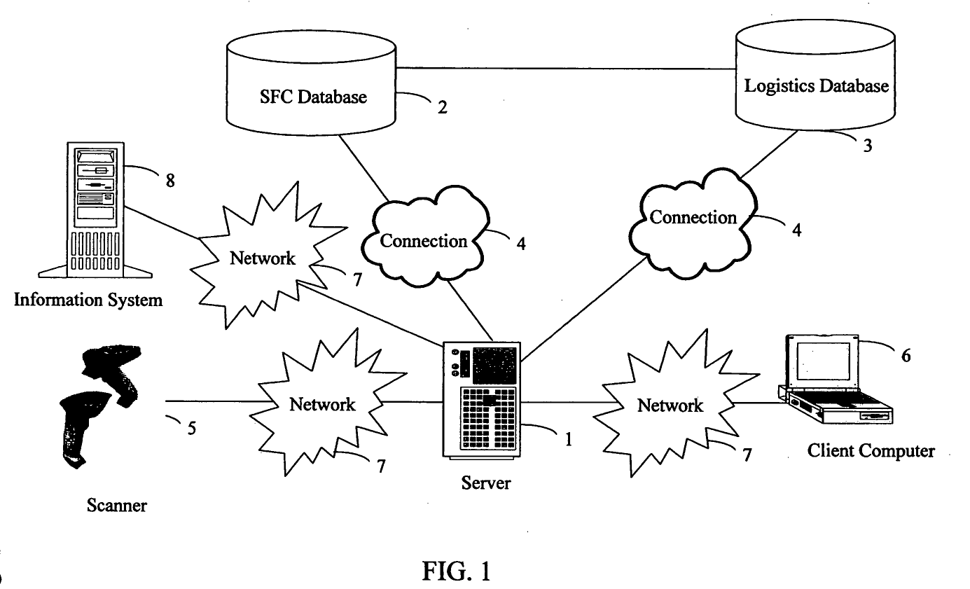

FIG. 1 is a schematic diagram of hardware configuration of a system for shipment control in accordance with the preferred embodiment of the present invention, together with an information system 8. The system for shipment control comprises a three-layer information system. The three-layer information system comprises a data access layer, a business logic layer, and a presentation layer. The data access layer comprises a Shop Floor Control (SFC) database 2 and a logistics database 3. The business logic layer comprises a server 1. The presentation layer comprises a plurality of client computers 6 and scanners 5. For the purposes of conveniently illustrating the preferred embodiment of the present invention, one client computer 6 and one scanner 5 are shown and described hereinafter. Networks 7 interconnect the business logic layer and the presentation layer. The server 1 connects with the information system 8 via a network 7. The networks 7 can each or in combination be the Internet, an intranet or another suitable kind of electronic communication network. Connections 4 interconnect the data access layer and the business logic layer. The connections 4 can each be an open database connectivity (ODBC), a Java database connectivity (JDBC), etc.

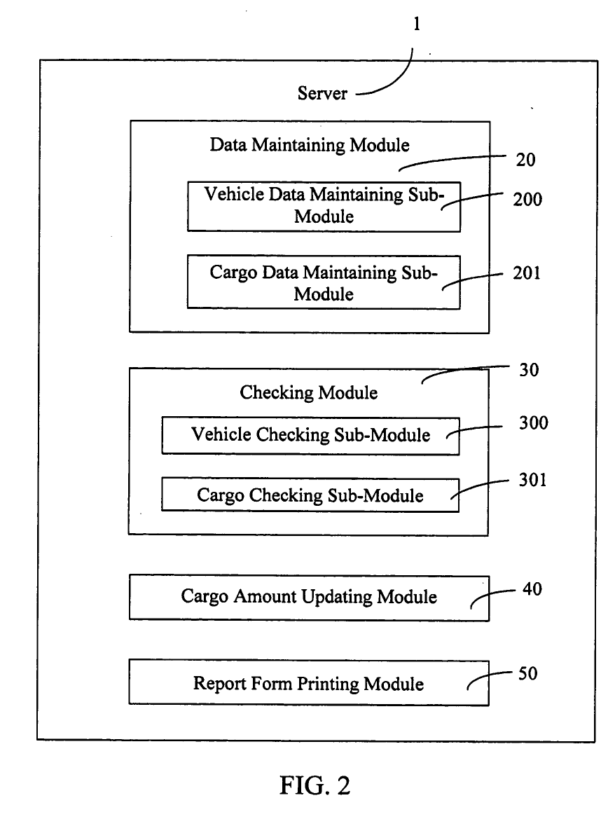

The server 1 comprises core and mutable enterprise logic (such as rules, execution, and management) of the system for shipment control. The server 1 comprises a plurality of software modules (described in detail below with reference to FIG. 2), and manages procedures of shipment in accordance with data input via the client computer 6 and the scanner 5.

The SFC database 2 stores data on vehicles and cargoes. These data are input by users via the client computer 6, and comprise data on IDs of vehicles, carrying capacities of the vehicles, IDs of drivers, detailed records on shipment, and shipper instructions. The shipper instructions include information on vehicle descriptions and corresponding cargoes. The logistics database 3 stores data on inventory of all cargoes, including data on amounts of different types of cargo. The information system 8 comprises a transportation control system and a cargo palleting system. The information system 8 stores data on the detailed records on shipment and shipper instructions.

The client computer 6 can use the operating system environment of Windows 95, Windows 98, Windows NT, etc., and provides an interactive user interface. The scanner 5 is an electronic device for reading bar codes of cargo and IDs of pallets of cargo. The pallets are used to store cargoes, and each pallet is a unit of a warehouse.

FIG. 2 is a schematic diagram of function modules of the server 1. The server 1 includes a data maintaining module 20, a checking module 30, a cargo amount updating module 40, and a report form printing module 50.

The data maintaining module 20 is used to add, modify, query and delete basic data on the vehicles and the cargoes. The data maintaining module 20 comprises a vehicle data maintaining sub-module 200, and a cargo data maintaining sub-module 201. The vehicle data maintaining sub-module 200 receives basic data on the vehicles from the client computer 6 and the scanner 5, and stores the basic data in the SFC database 2. The basic data comprise IDs of the vehicles, carrying capacities of the vehicles, IDs of drivers, detailed records on shipment, and shipper instructions. The cargo data maintaining sub-module 201 receives IDs of detailed records on shipment and IDs of the shipper instructions from input of users via the client computer 6, and stores these IDs in the SFC database 2. The system for shipment control can compare these IDs with corresponding data on detailed records on shipment and shipper instructions stored in the information system 8, and check whether the data stored in the information system 8 is accurate.

The checking module 30 is used to check whether a vehicle is loaded with correct cargo by comparing data stored in the SFC database 3 with corresponding data in the information system 8. The checking module 30 comprises a vehicle checking sub-module 300, and a cargo checking sub-module 301. The vehicle checking sub-module 300 receives an ID of a vehicle input by a user, compares the ID with corresponding data on the vehicle stored in the SFC database 3, and thereby checks whether the ID of the vehicle is correct. The data on the vehicle stored in the SFC database 3 comprises the ID of the vehicle, a carrying capacity of the vehicle, and an ID of the driver of the vehicle. The cargo checking sub-module 301 is used to receive bar codes of the cargo and bar codes of the pallets via the scanner 5, compares the bar codes with corresponding data on the cargo stored in the corresponding detailed record on shipment and a corresponding load requisition, and thereby checks whether the cargo is correct.

The cargo amount updating module 40 is used to update data on cargo amounts in the inventory of cargoes stored in the logistics database 3 in accordance with data on amounts and types of cargo stored in detailed records on shipment, and can display an up-to-date statement on a status of loading of cargo.

The report form printing module 50 is used to print a pass form via the client computer 6 when cargo loading and checking are finished. The pass form comprises data on the ID of the vehicle, a cargo list, the ID of driver, etc.

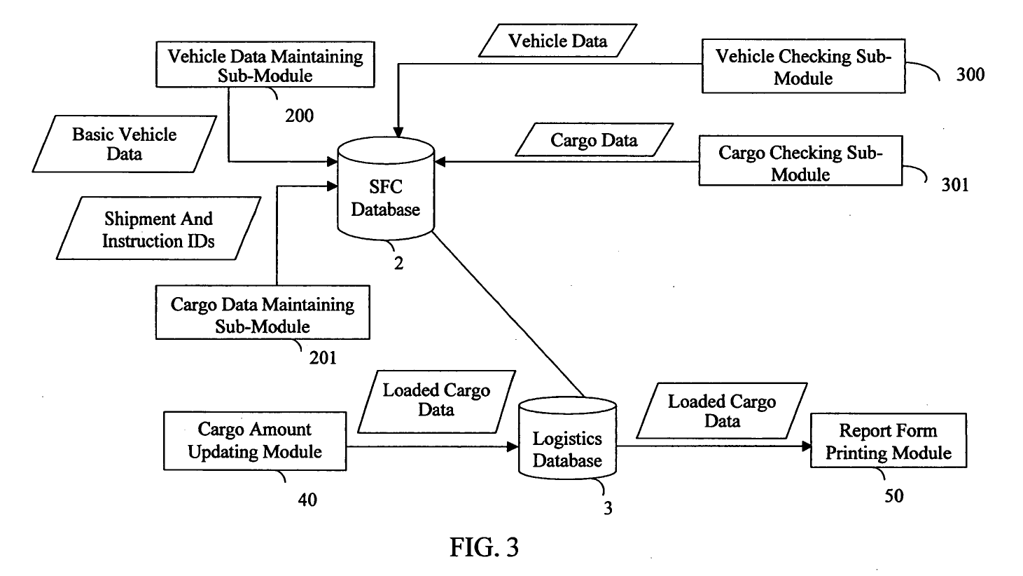

FIG. 3 is a data flow chart of the system for shipment control. The vehicle data maintaining sub-module 200 stores the basic vehicle data in the SFC database 2 via the client computer 6. The basic vehicle data comprise IDs of vehicles, carrying capacities of vehicles, and IDs of drivers. The cargo data maintaining sub-module 201 stores IDs of detailed records on shipment and IDs of shipper instructions in the SFC database 2. These latter two IDs are used to check corresponding detailed records on shipment and shipper instructions stored in the information system 8. When a vehicle arrives at a warehouse for loading of cargo thereon, the vehicle checking sub-module 300 reads the ID of the vehicle via the scanner 5, and checks whether the vehicle accords with the basic vehicle data stored in the SFC database 2. When loading the cargo, the cargo checking sub-module 301 receives cargo data via the scanner 5, and checks bar codes of the cargo and the pallets of the cargo in accordance with data stored in the corresponding detailed record on shipment stored in the information system 8. During loading of the cargo, the cargo amount updating module 40 updates data on cargo amounts in the inventory of cargoes stored in the logistics database 3 in accordance with data stored in the corresponding detailed record on shipment, displays the latest loading status statement, and sends the data on cargo loading and the vehicle to the information system 8 via the network 7. When the loading of cargo is finished, the report form printing module 50 prints a pass form in accordance with loaded cargo data stored in the logistics database 3.

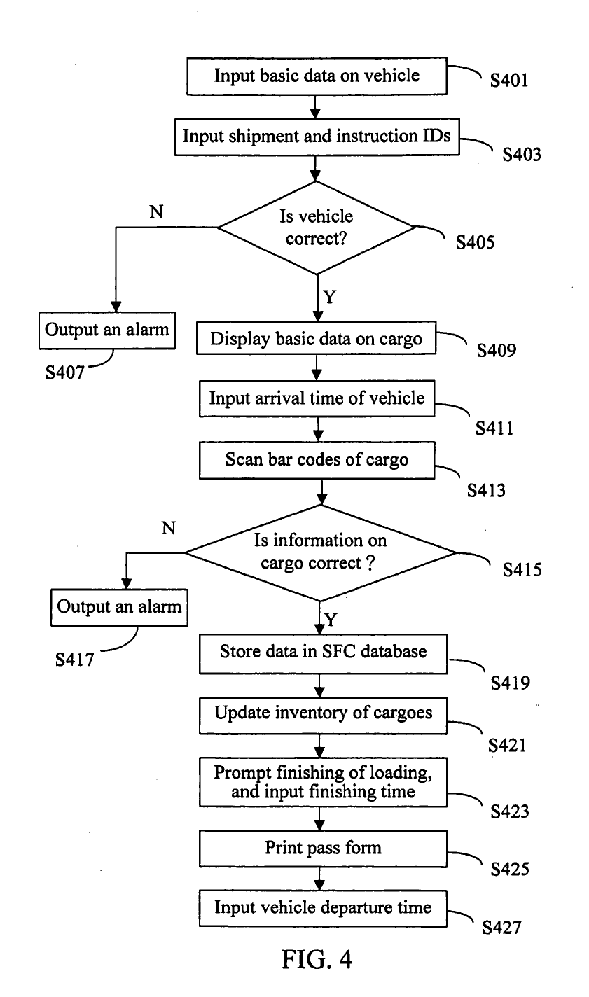

FIG. 4 is a flow chart of preferred operation of the system for shipment control. In step S401, the vehicle data maintaining sub-module 200 receives basic data on vehicles input by a user via the client computer 6, and stores the data in the SFC database 2. The basic data on vehicles comprise IDs of the vehicles, carrying capacities of the vehicles, and IDs of drivers. In step S403, the cargo data maintaining sub-module 201 receives an ID of a detailed record on shipment and an ID of a shipper instruction both input by the user via the client computer 6, and stores these IDs in the SFC database 2. In step S405, the vehicle checking sub-module 300 reads an ID of a vehicle via the scanner 5, and checks whether the vehicle accords with corresponding basic data on vehicles stored in the SFC database 2. If the vehicle does not accord with the data, in step S407, the system for shipment control outputs an alarm via the scanner 5.

If the vehicle accords with the data, in step S409, the client computer 6 displays basic data on cargo corresponding to the vehicle. The basic data on cargo comprise an ID and an amount of the cargo. In step S411, an arrival time of the vehicle is input by the user via the client computer 6, and the cargo data maintaining sub-module 201 stores the arrival time data in the SFC database 2. In step S413, the scanner 5 reads bar codes of the cargo to obtain more information relating thereto. The information comprises pallet codes, an amount of pallets, an amount of boxes, and an ID of the shipper instruction. In step S415, the cargo checking sub-module 301 checks the information on the cargo, and determines whether the information accords with the detailed record on shipment. If the information does not accord with the detailed record on shipment, in step S417, the system outputs an alarm via the scanner 5, and the client computer 6 displays an error message.

If the information accords with the detailed record on shipment, in step S419, the cargo data maintaining sub-module 201 stores the information on the cargo in the SFC database 2. In step S421, the cargo amount updating module 40 updates cargo amounts in the inventory of cargoes stored in the logistics database 3 in accordance with the detailed record on shipment. When loading and checking are finished, in step S423, the client computer 6 prompts the user to initiate a “finished loading” message, and generates a time of finishing of the loading. In step S425, the report form printing module 50 prints a pass form for the cargo. The pass form comprises data on the ID of the vehicle, the ID and the amount of the cargo, and an ID of the driver. In step S427, the vehicle data maintaining sub-module 200 generates a time of departure of the vehicle, and stores the time of departure in the SFC database 2.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for shipment control, the system comprising a shop floor control database, a logistics database, a scanner, a client computer, a server and a network interconnecting the above devices, wherein:
the shop floor control database stores data on vehicles, IDs of detailed records on shipment, and IDs of shipper instructions;
the logistics database stores inventory data;
the scanner scans bar codes of vehicles and bar codes of cargoes;
the client computer is used to input and query the detailed records on shipment, shipper instructions, and data on the vehicles; and
the server comprises:
a data maintaining module for adding, modifying, querying, and deleting data on vehicles and cargoes;
a checking module for checking whether vehicles are loaded with correct cargoes;
a cargo amount updating module for updating inventory data stored in the logistics database in accordance with data on loaded cargoes and the detailed records on shipment.

2. The system as claimed in claim 1, wherein the data on the vehicles comprise IDs of the vehicles, carrying capacities of the vehicles, and IDs of drivers.

3. The system as claimed in claim 1, wherein the data maintaining module comprises:
a vehicle data maintaining sub-module for maintaining the data on the vehicles stored in the shop floor control database; and
a cargo data maintaining sub-module for maintaining IDs of the detailed records on shipment and IDs of the shipper instructions stored in the shop floor control database.

4. The system as claimed in claim 3, wherein the checking module comprises:
a vehicle checking sub-module for checking whether IDs of vehicles input via the scanner accord with the data on the vehicles stored in the shop floor control database;
a cargo checking sub-module for checking whether IDs and amounts of cargoes input via the scanner accord with the detailed records on shipment.

5. A method for shipment control, the method comprising the steps of:
inputting data on vehicles to a shop floor control database;
inputting an ID of a vehicle to check the vehicle in accordance with the data on the vehicles stored in the shop floor control database;
inputting an ID of a detailed record on shipment and storing the ID in the shop floor control database;
inputting an ID of a shipper instruction and storing the ID in the shop floor control database;
checking data stored in the detailed record on shipment in accordance with the ID of the detailed record on shipment;
checking data stored in the shipper instruction in accordance with the ID of the shipper instruction;
inputting one or more bar codes of cargo and checking data stored in the detailed record on shipment; and
updating inventory data stored in a logistics database.

6. The method as claimed in claim 5, wherein the step of checking data stored in the detailed record on shipment in accordance with the ID of the detailed record on shipment further comprises the step of:
outputting an alarm if the data stored in the detailed record on shipment is not in accordance with the ID of the detailed record on shipment.
